(19) United States
(12) Patent Application Publication
(10) Pub. No.: US 2012/0063297 A1
(43) Pub. Date: Mar. 15, 2012

(54) USER TERMINAL AND METHOD FOR RADIO RESOURCE CONNECTION THEREOF

(75) Inventor: Sung Jin HONG, Hwaseong-si (KR)

(73) Assignee: PANTECH CO., LTD., Seoul (KR)

(21) Appl. No.: 13/197,444

(22) Filed: Aug. 3, 2011

(30) Foreign Application Priority Data
Sep. 10, 2010 (KR) 10-2010-0088700

(51) Int. Cl. H04W 52/22

(52) U.S. Cl. 370/216

(57) ABSTRACT

In a user terminal and a method for a radio resource connection thereof, the user terminal includes a communication unit to transmit a request signal to request a radio resource connection and to receive a response signal in response to the request signal, a control unit to generate the request signal, to select a first cell based on the response signal and to determine whether to retransmit a request signal to the first cell based on a timer; and a timer management unit to start the timer.

### CROSS-REFERENCE TO RELATED APPLICATION

This application claims priority from and the benefit under 35 U.S.C. §119(a) of Korean Patent Application No. 10-2010-0088700, filed on Sep. 10, 2010, which is incorporated by reference for all purposes as if fully set forth herein.

### BACKGROUND

1. Field

The following description relates to a terminal and method for a radio resource connection, and more particularly, to a user terminal and method for requesting a radio resource connection of a user terminal.

2. Discussion of the Background

As radio communication systems have evolved, various cell structures for a is communication system have emerged such as a micro-cell, a macro-cell, and a femto-cell. If various kinds of cells exist around a user terminal, a temporal communication interruption may occur due to interference between cells. Further, the user terminal may not receive communication services when the user terminal is located in a cell-overlapping area.

A user terminal may request a radio resource connection to a designated cell so as to receive radio communication services from the designated cell. If the user terminal requests the radio resource connection repeatedly due to a communication interruption and the like, transmission channels may be wasted in proportion to the number of re-requests, or signal processing load may be increased.

### SUMMARY

Exemplary embodiments of the present invention provide a user terminal and a method for a radio resource connection including requesting a radio resource connection to a first cell, determining a failure of the radio resource connection to the first cell based on a timer, and requesting a radio resource connection to a second cell after determining the failure.

Additional features of the invention will be set forth in the description which follows, and in part will be apparent from the description, or may be learned by practice of the invention.

Exemplary embodiments of the present invention provide a method for a radio resource connection, including transmitting a request for a radio resource connection to a first cell, and driving a first retransmission timer based on cell information of the first cell; determining a failure of the radio resource connection to the first cell based on the first retransmission timer; driving a Tcp-cell timer for stopping the re-request of the radio resource is connection to the first cell for a period of time; and requesting a radio resource connection to a second cell.

Exemplary embodiments of the present invention provide a method for a radio resource connection, including requesting a radio resource connection to a first cell; requesting a radio resource connection to a second cell if the first cell is determined as a capricious cell; and determining whether to perform a re-request of a radio resource connection to the first cell if the second cell is determined as a capricious cell.

Exemplary embodiments of the present invention provide a terminal including a communication unit to transmit and receive a message for radio resource connection to and from a base station; a control unit to request a radio resource connection to a first cell, to request the radio resource connection to a second cell if the first cell is determined as a capricious cell (CP-cell), and to determine whether to re-request the radio resource connection to the first cell based on a Tcp-cell timer; and a timer management unit to manage the Tcp-cell timer for stopping the re-request for the radio resource connection to the first cell for a period of time.

Exemplary embodiments of the present invention provide a terminal including a communication unit to transmit a first request for a radio resource connection and to receive a response to the request; a control unit to generate the request, to select a first cell based on the response, and to determine whether to transmit a second request to the first cell based on a timer; and a timer management unit to start the timer.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a view illustrating a communication environment according to an exemplary embodiment of the present invention.

FIG. 2 is a view illustrating a process for a radio resource connection of a user terminal according to an exemplary embodiment of the present invention.

FIG. 3 is a flowchart illustrating a method for a radio resource connection of a user terminal according to an exemplary embodiment of the present invention.

FIG. 4 is a block diagram illustrating a user terminal according to an exemplary embodiment of the present invention.

FIG. 5 is a flowchart illustrating a method for radio resource communication of a user terminal according to an exemplary embodiment of the present invention.

FIG. 6 is a flowchart illustrating a method for radio resource communication of a user terminal according to an exemplary embodiment of the present invention.

FIG. 7 is a flowchart illustrating a process of searching for a cell and a process of initializing a radio resource connection according to an exemplary embodiment of the present invention.

FIG. 8 is a flowchart illustrating an example of process ‘A’ referred to in FIG. 7, FIG. 9, and FIG. 12 according to an exemplary embodiment of the present invention.

FIG. 9 is a flowchart illustrating an example of process ‘C’ referred to in FIG. 8 is according to an exemplary embodiment of the present invention.

FIG. 10 is a flowchart illustrating a procedure of a portion of operation 540 illustrated in FIG. 5 according to an exemplary embodiment of the present invention.

FIG. 11 is a flowchart illustrating an example of process ‘B’ referred to FIG. 8 according to an exemplary embodiment of the present invention.

FIG. 12 is a flowchart illustrating an example of process ‘E’ referred to in FIG. 11 according to an exemplary embodiment of the present invention.

FIG. 13 is a flowchart illustrating an example of process ‘D’ referred to in FIG. 5, FIG. 6, FIG. 9, FIG. 10, and FIG. 12 according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity Like reference numerals in the drawings denote like elements.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X).

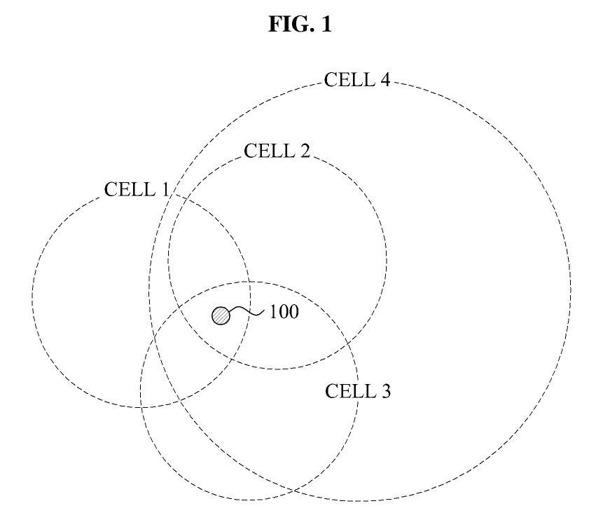

FIG. 1 is a view illustrating a communication environment according to an exemplary embodiment of the present invention.

Referring to FIG. 1, multiple cells such as Cell1, Cell2, Cell3, and Cell4 may exist around a user terminal 100. The multiple cells, Cell1, Cell2, Cell3 and Cell4, may be formed by the coverage areas of corresponding base stations, respectively. For example, the Cell1 may be a cell formed by a macro base station, the Cell2 may be a cell formed by a small-sized base station, and the Cell3 may be a cell formed by a femtocell-based base station. In the following descriptions, a ‘cell’ may be used as the same meaning as a ‘base station that forms the corresponding cell’ or the ‘communication coverage area of a base station’. For example, cells that exist around a user terminal 100 may have the same meaning as base stations that exist around the user terminal 100. Also, in the radio communication environment, a failure in ‘response’ to ‘request’ may occur due to a ‘timing delay’, a ‘synchronization error’, and the like.

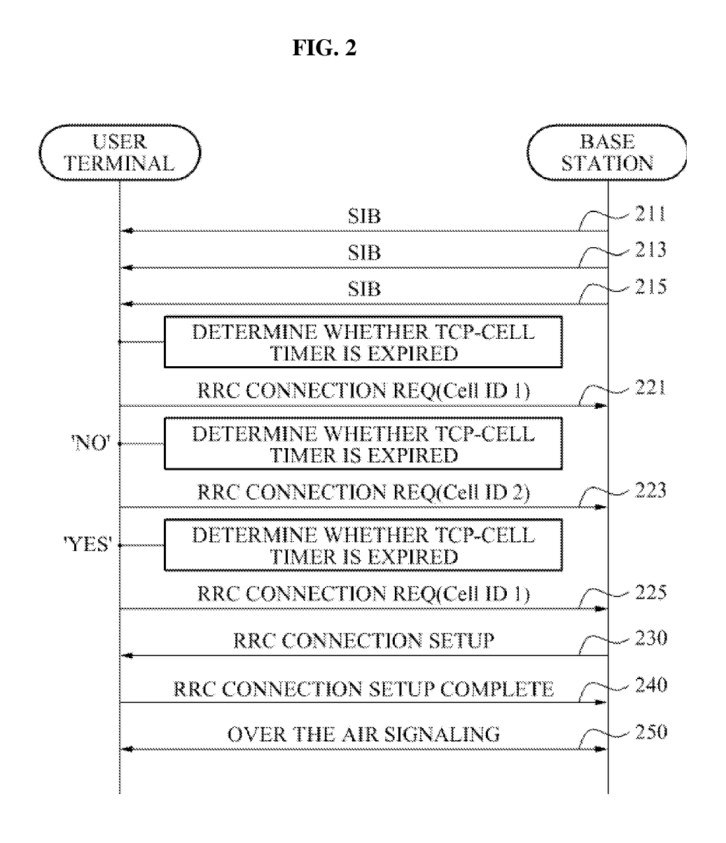

FIG. 2 is a view illustrating a process for a radio resource connection of a user terminal according to an exemplary embodiment of the present invention.

Referring to FIG. 2, in operations 211, 213, and 215, the user terminal receives a system information block (SIB) from one or more base stations. The SIB is cell information on a cell that exists around the user terminal. That is, each SIB includes information on a specific cell that exists around the user terminal. In this instance, the cell information may include ‘N300’, the number of retransmissions of a ‘radio resource control (RRC) connection request message’ allowed in the corresponding cell. The cell information may also include ‘T300’, the value of a retransmission request timer of the ‘RRC connection request message’. The cell information may s also include information on a power level for transmitting the ‘RRC connection request message’. The cell information may also include an identifier (ID) of the corresponding cell.

The ‘RRC connection request message’ may include a random access channel preamble ('RACH preamble'). The ‘RACH preamble’ may use Hadamard codes having a length of 16 chips.

In operations 221, 223, and 225, the user terminal requests a radio resource connection to a base station. The radio resource connection request may be performed by transmitting the ‘RRC connection request message’ to the base station. In the example illustrated in FIG. 2, operations 221 and 225 show that the radio resource connection request to the base station, which has a cell identifier (CELL ID) as 1, is performed two times. The user terminal is cannot recognize whether the ‘RRC connection request message’ is received by the base station having CELL ID 1 without receiving a response from the base station having CELL ID 1. Therefore, if the user terminal does not receive a response from the base station having CELL ID 1 before the expiration of a specific timer and it is determined that a timer, Tcp-cell timer, is expired, the user terminal retransmits the ‘RRC connection request message’ to the base station having CELL ID 1.

If the user terminal receives an ‘RRC connection setup (RCS) message’ from the base station having CELL ID 1 in operation 230, the user terminal sets up the radio resource connection using the received ‘RCS message’. The ‘RCS message’ is a response signal for the radio resource connection request. The user terminal may determine the failure of the radio resource connection based on the reception of the response signal for the radio resource connection request before the expiration of a timer. The ‘RCS message’ may include an ‘RACH message’ corresponding to a random access channel preamble (RACH preamble).

In operation 240, the user terminal transmits an ‘RRC Connection Setup (RCS) completion message’ to the corresponding base station, thereby completing the radio resource connection.

In operation 250, the user terminal and the corresponding base station may perform signaling through a radio channel or may transmit and receive data packets.

Also, the radio resource connection procedure may be a contention based procedure. In the contention based procedure, if the user terminal does not receive an acknowledge (ACK) signal for the ‘RACH preamble’ in a certain time period, the user terminal may increase transmission power and then retransmit the ‘RACH preamble’. Conventionally, if the radio resource connection request is repeatedly performed with respect to the same cell, the transmission power of the user terminal may also be wasted.

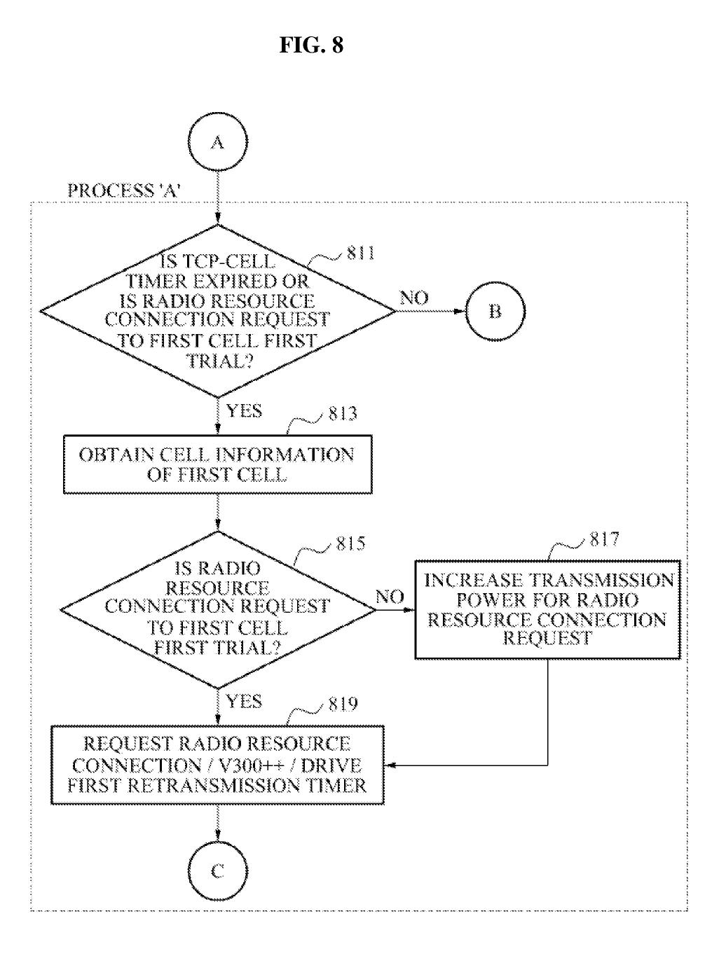

According to the exemplary embodiment, before transmitting RRC connection request message to a specific cell, the user terminal determines whether Tcp-cell timer for the specific cell is expired. If the Tcp-cell timer is not expired, the user terminal transmits RRC connection request message to second best cell. Thus, Tcp-cell timer may be used to eliminate the problem that the user terminal repeatedly transmits the RRC connection request message to one cell without a trial to make radio resource connection with the other cells. The Tcp-cell timer will be described in more detail with reference to FIG. 8.

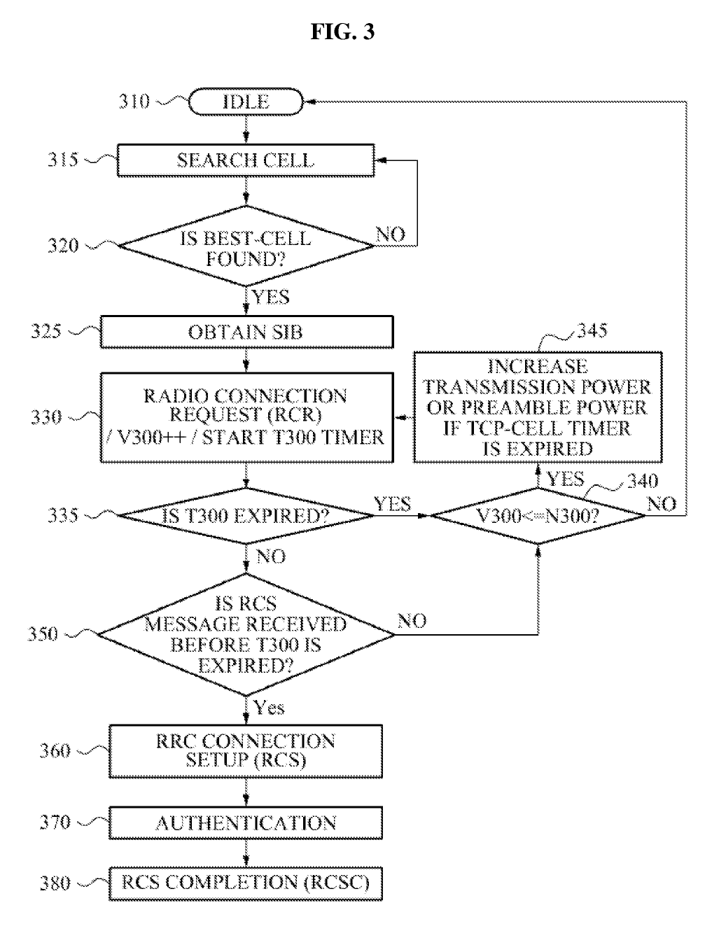

FIG. 3 is a flowchart illustrating a method for a radio resource connection of a user terminal according to an exemplary embodiment of the present invention.

Referring to FIG. 3, the user terminal maintains an idle mode in operation 310 and performs cell searching in operation 315. The ‘cell searching’ is performed to find accessible cells that exist around the user terminal. The user terminal may obtain electric field strength for each of the cells that exist around the user terminal through the ‘cell searching’, and generate a list of cells in the descending order of the electric field strength.

In operation 320, the user terminal determines whether the most appropriate cell, a best-cell, is found. That is, the user terminal determines whether a cell exists that satisfies an optimal condition for radio communication among the list of cells. In this instance, the ‘optimal condition’ may be determined according to whether received signal characteristics such as the intensity of electric field strength, the degree of interference, and the quality of a reception signal, satisfy certain conditions. If the user terminal does not find the best-cell, the user terminal may perform the cell searching again. Operations 310 to 320 may be performed based on a scheme defined by a communication standard.

In operation 325, the user terminal obtains a SIB of the best-cell.

In operation 330, the user terminal requests a radio resource connection to the best-cell. In this instance, the user terminal drives a T300 timer included in the SIB and increases V300 by ‘1’. The T300 timer is a timer of which expiration time is set as T300. The V300 is a value for counting the number of radio resource connection requests. Also, the T300 and N300 may be different or identical for each cell. For example, the T300 and N300 may be set in consideration of the system performance of a corresponding cell, the data processing time of the corresponding cell, and the like.

In operation 335, the user terminal determines whether the T300 timer is expired. If the T300 timer is not expired, the user terminal determines whether an ‘RCS message’ is received before the T300 timer is expired in operation 350. If the T300 timer is expired, the user terminal compares the V300 with the N300 in operation 340.

In operation 340, if the V300 is greater than the N300, the user terminal repeats s operations 310 to 335. That is, the user terminal terminates the radio resource connection request for the best-cell and performs a procedure for searching a new cell.

If the V300 is smaller than or identical to the N300, the user terminal determines whether Tcp-cell timer for the cell is expired. If the Tcp-cell timer for the cell is expired, the user terminal increases transmission power in operation 345 and then performs operation 330. That is, the user terminal increases the transmission power and then re-requests the radio resource connection to the same cell. The user terminal may increase preamble transmission power. In operation 350, if the user terminal determines an ‘RCS message’ is received before the T300 timer is expired, the user terminal performs operation 360. If the user terminal determines no ‘RCS message’ is received before the T300 timer is expired, the user terminal performs is operation 340.

In operation 360, the user terminal processes the ‘RCS message’ for the purpose of the radio resource connection, and performs an authentication process in operation 370. The user terminal performs the authentication process and then transmits the ‘RCS completion message’ to the best-cell in operation 380.

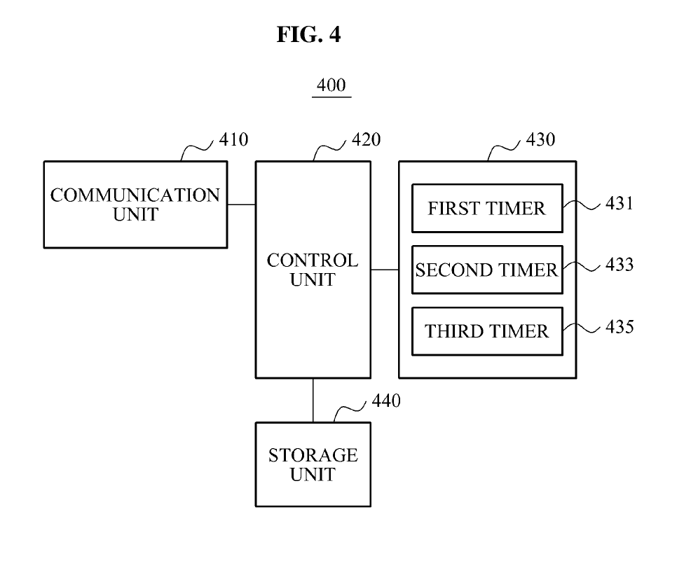

FIG. 4 is a block diagram illustrating a user terminal according to an exemplary embodiment of the present invention.

Referring to FIG. 4, the user terminal 400 includes a communication unit 410, a control unit 420 and a timer management unit 430. The user terminal 400 may further include a storage unit 440.

The communication unit 410 transmits and receives a message for a radio resource connection to and from a base station. That is, the communication unit 410 may transmits the message to the base station under the control of the control unit 420. The s communication unit 410 may receive a SIB from a specific cell, and provide the received SIB to the control unit 420.

The control unit 420 may control the entire operation of the user terminal 400. The control unit 420 requests a radio resource connection to a first cell that satisfies an optimal condition for radio communication among cells that exist around the user terminal 400. The optimal condition may be determined by calculating quantified values of received signal characteristics such as the intensity of electric field strength, the degree of interference, and the quality of a reception signal and by evaluating the quantified values. The evaluation of the quantified values of the received signal characteristics may be performed by comparing each of the quantified values with corresponding threshold values or by comparing weighted average is values of the quantified values with a weighted average threshold value. Alternatively, the weighted average values or the quantified values may be compared with those of the other cells that exist around the user terminal 400. The control unit 420 may request the radio resource connection to the corresponding cell, the first cell which satisfies the optimal condition, by transmitting an ‘RRC connection request message’ through the communication unit 410. The first cell means a best-cell that satisfies the optimal condition for radio communication.

If the control unit 420 does not receive a response for the radio resource connection request from the first cell before a first retransmission timer for the first cell is expired, the control unit 420 requests the radio resource connection to a second cell. The expiration time of the first retransmission timer is the same value as T300 obtained from the SIB of the first cell. The second cell may be a cell of which communication environment is superior to communication environment of the cells that exist around the user terminal 400 except the first cell. That is, the second cell may be a cell that satisfies a secondary best condition for radio s communication among the cells that exist around the user terminal 400. The second cell may be a cell for which conditions for radio communication are superior to the cells except cells for which radio resource connection is not currently stable. Cells for which radio resource communication is not currently stable may include capricious cells. For example, Cell 2, Cell 3 and Cell 4 are assumed to exist around the user terminal 400 in the order of superior communication conditions. If the Cell 2 and Cell 3 are capricious cells (CP-cells) for which radio resource connections are not temporarily stable, the second cell may be the Cell 4. Further, if the second cell, Cell 4, is determined as a CP-cell and Cell 5 is determined as a cell for which condition for radio communication is superior to the cells except cells for which radio resource connection is not currently stable, Cell 5 becomes a ‘second cell’. Thus, the second cell may mean a cell for which conditions for radio communication are superior to the cells that exist around the terminal except the CP-cells at that time. Further, the control unit 420 may determine a cell as a capricious cell if the user terminal 400 does not receive a response for a radio resource connection request from the cell before a retransmission timer for the cell expires. Alternatively, the control unit 420 may determine a cell as a capricious cell if the user terminal 400 does not receive a response for a radio resource connection request from the cell before a retransmission timer for the cell expires and the number of radio resource connection requests to the cell, such as ‘V300’, and ‘V300CP’, is not larger than a reference value such as ‘N300’, and ‘N300CP’

If the control unit 420 does not receive a response for the radio resource connection request from the second cell before a second retransmission timer for the second cell is expired, the control unit 420 re-requests the radio resource connection to the first cell. The expiration time of the second retransmission timer is the same value as T300 obtained from the SIB of the second cell. Hereinafter, for convenience of description, the T300 obtained from the SIB of the second cell will be referred to as ‘T300cp’, and the N300 obtained from the SIB of the second cell will be referred to as ‘N300cp’.

Also, the control unit 420 may include a processor. The processor may be configured to request a radio resource connection to the first cell, to request the radio resource connection to the second cell if the processor does not receive a response for the radio resource connection request from the first cell before the first retransmission timer is expired, and to re-request the radio resource connection to the first cell if the processor does not receive the radio resource connection request from the second cell before the second retransmission timer is expired.

If the radio resource connection request for the first cell is not the first trial for the first cell, the control unit 420 may increase transmission power for the radio resource connection request. If the number of radio resource connection requests to the first cell is not larger than a reference value obtained from cell information of the first cell, the control unit 420 may determine the first cell as a CP-cell for which radio resource connection is not stable. The cell information of the first cell may be obtained from the SIB of the first cell, and the reference value obtained from the cell information may be N300 of the first cell. If the control unit 420 does not receive a response for the radio resource connection request from the second cell before the second retransmission timer is expired, the control unit 420 may re-transmit a request for the radio resource connection to the first cell based on the expiration of a Tcp-cell timer. That is, the control unit 420 may re-transmit a request for the radio resource connection to the first cell if the Tcp-cell timer is expired.

Also, the control unit 420 may set up the value of the Tcp-cell timer with reference to the T300 obtained from the SIB. In this instance, the control unit 420 sets up the value of the Tcp-cell timer to be smaller than T300. The Tcp-cell timer is a timer for stopping the re-request for the radio resource connection to the same cell for a certain period of time. That is, the Tcp-cell timer is a timer introduced in consideration of a case where the cell currently determined as a CP-cell may escape from a temporary interruption and provide a normal service. After the Tcp-cell timer is expired, the radio resource connection may be requested to the cell currently determined as a CP-cell.

The timer management unit 430 manages the operations of retransmission timers including the first retransmission timer, the Tcp-cell timer and the second retransmission timer. That is, the timer management unit 430 may start each of the retransmission timers, and transmit start information of a corresponding timer or expiration information of the corresponding timer to the control unit 420 under a request of the control unit 420.

The timer management unit 430 may include a first timer 431, a second timer 433, and a third timer 435. In one aspect, the first timer 431, the second timer 433, and the third timer 435 may be a first retransmission timer, a second retransmission timer and a Tcp-cell timer, respectively.

The storage unit 440 may store the list of cells that exist around the user terminal 400, the number of radio resource connection requests to a specific cell, the system broadcasting information of a specific cell and the list of CP-cells of which radio resource connections are currently not stable. The storage unit 440 may include a memory. Further, the storage unit 440 may store information of a capricious cell. The information of a capricious cell may include information indicating whether a cell is a capricious cell. The storage unit 440 may store at least one of the value of Tcp-cell timer of a cell, a start time of a Tcp-cell timer (a start time of driving a Tcp-cell timer), and an expiration time of a Tcp-cell timer. The storage unit 440 may store the list of capricious cells of which radio resource connections are not stable.

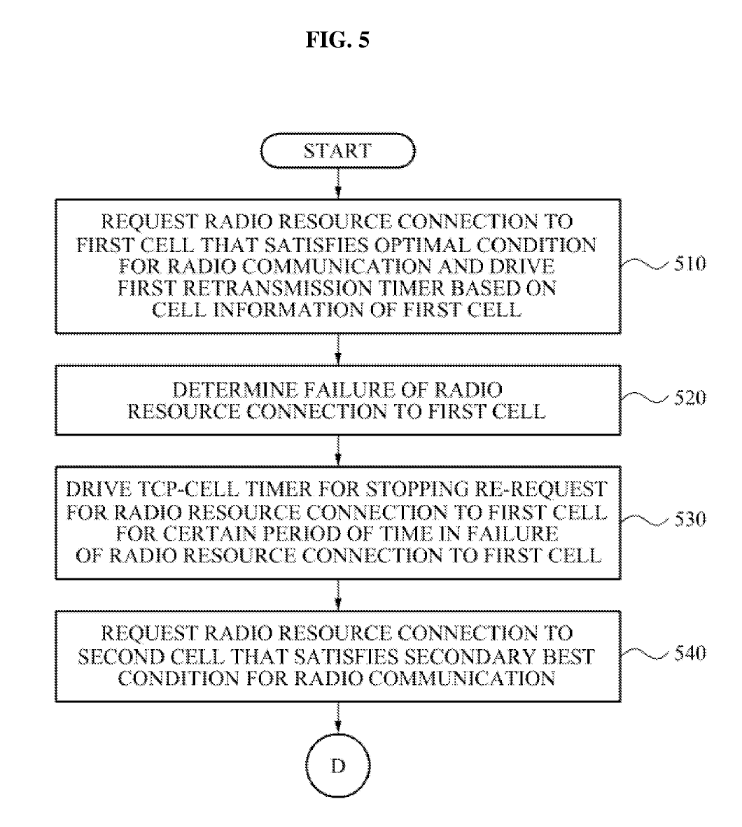

FIG. 5 is a flowchart illustrating a method for radio resource communication of a user terminal according to an exemplary embodiment of the present invention.

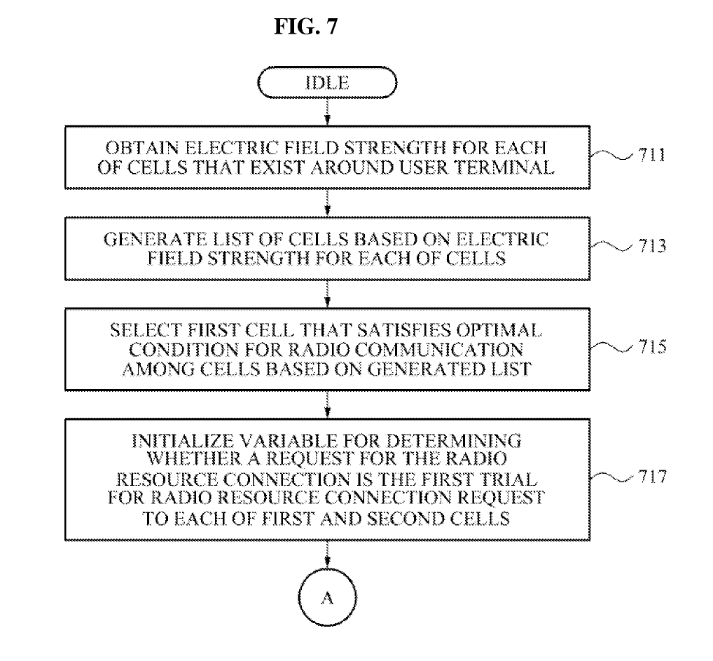

Referring to FIG. 5, in operation 510, the user terminal requests a radio resource connection to a first cell that satisfies an optimal condition for radio communication among cells that exist around the user terminal, and drives a first retransmission timer based on cell information of the first cell. Operation 510 may include a cell searching process and a radio resource connection initialization process, illustrated in FIG. 7. Operation 510 may also include a process of increasing transmission power for the radio resource connection request if the radio resource connection request for the first cell is not a first trial for the first cell.

In operation 520, the user terminal determines a failure of the radio resource connection to the first cell based on the driven first retransmission timer and the reception of a response signal for the radio resource connection request. Operation 520 may include process ‘A’ illustrated in FIG. 8.

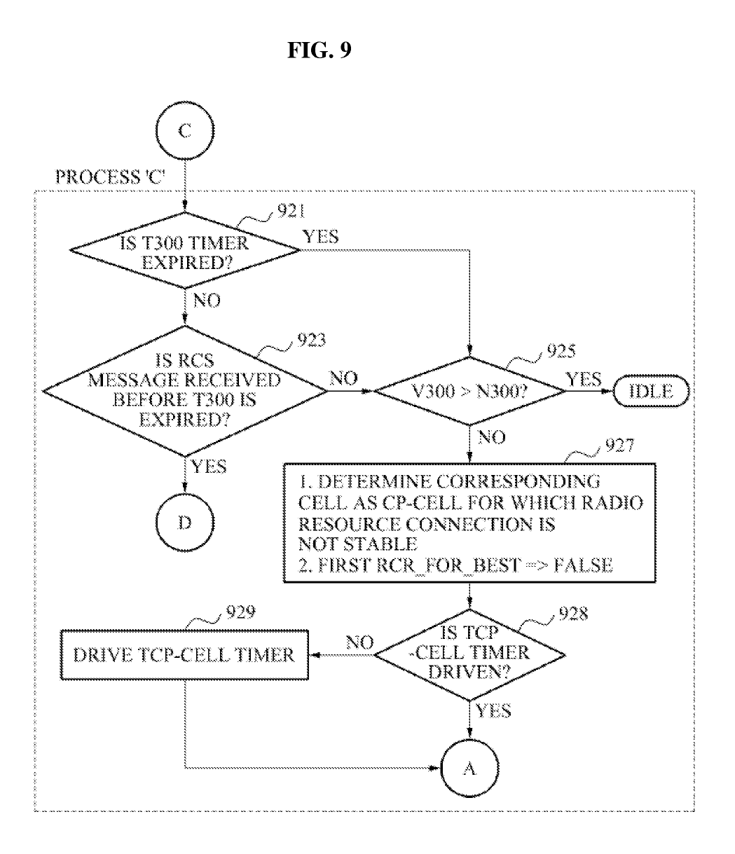

In operation 530, the user terminal drives a Tcp-cell timer for stopping the re-request for the radio resource connection to the first cell for a certain period of time if the user terminal fails in the radio resource connection to the first cell. Operation 530 may include process ‘C’ illustrated in FIG. 9.

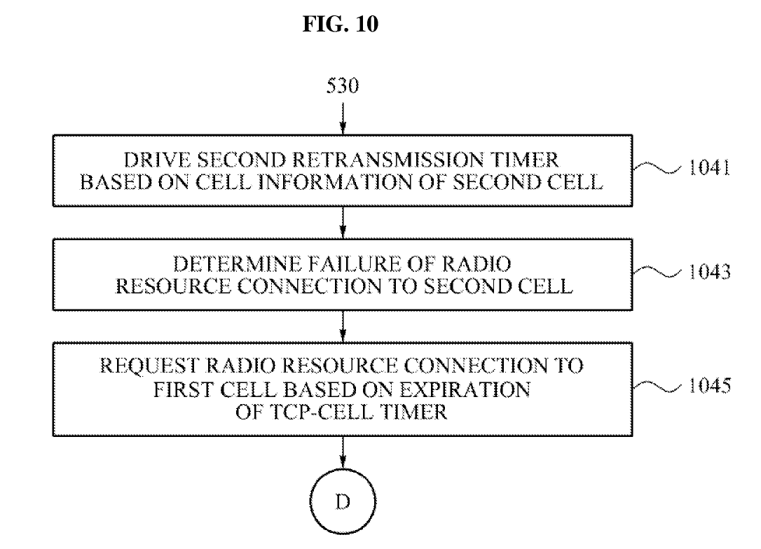

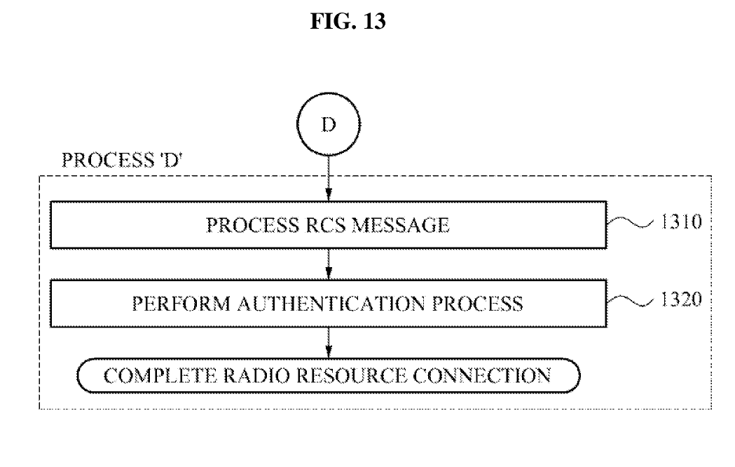

In operation 540, the user terminal requests the radio resource connection to a second cell that satisfies a secondary best condition for radio communication among the cells that exist around the user terminal. Accordingly, if the user terminal fails in the radio resource connection to a best-cell, the user terminal may request the radio resource connection to a cell for which conditions for radio communication are superior to the cells that exist around the user terminal except the best-cell, before the user terminal re-requests the radio resource connection to the best cell. If the user terminal receives a response signal for the radio resource connection request from the second cell, the user terminal performs process ‘D’ illustrated in FIG. 13. Operation 540 may include a process illustrated in FIG. 10.

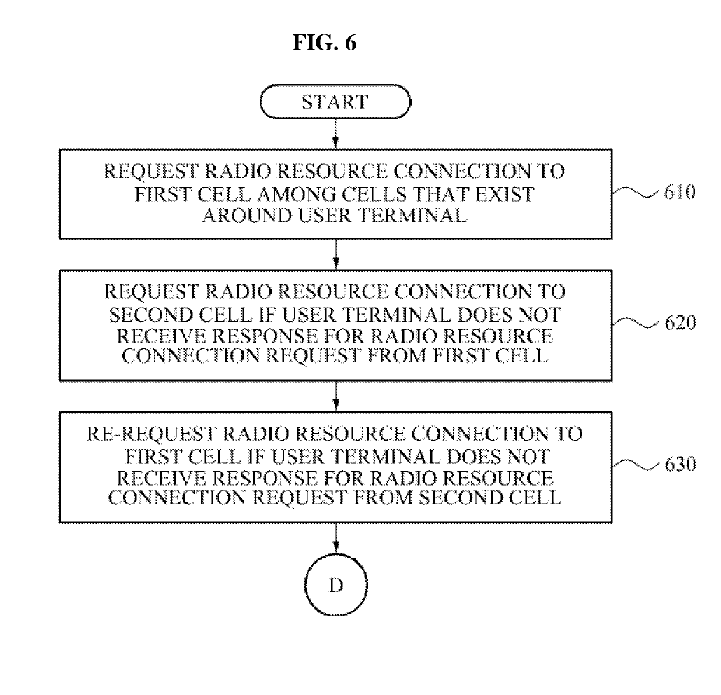

FIG. 6 is a flowchart illustrating a method for radio resource communication of a user terminal according to an exemplary embodiment of the present invention.

Referring to FIG. 6, in operation 610, the user terminal requests a radio resource connection to a first cell among cells that exist around the user terminal. In this instance, the first cell may be a best-cell that satisfies an optimal condition for radio communication among the cells that exist around the user terminal. Operation 610 may include a cell searching process and is a radio resource connection initialization process, illustrated in FIG. 7.

In operation 620, if the user terminal does not receive a response for the radio resource connection request from the first cell before a first retransmission timer corresponding to the first cell is expired, the user terminal requests the radio resource connection to a second cell. In this instance, the second cell may be a cell that satisfies a secondary best condition for radio communication among the cells that exist around the user terminal. In operation 620, the user terminal drives the first retransmission timer based on cell information of the first cell, and compares the number of radio resource connection requests to the first cell with a reference value obtained from the cell information of the first cell. If the number of radio resource connection requests is not larger than the reference value, the user terminal may determine the first cell as a CP-cell of which radio resource connection is not stable, and drive a Tcp-cell timer for stopping the re-request for the radio resource connection to the first cell for a certain period of time.

In operation 630, if the user terminal does not receive a response for the radio resource connection request from a second cell before a second retransmission timer corresponding to the second cell is expired, the user terminal may re-request the radio resource connection to the first cell. In operation 630, the user terminal drives the second retransmission timer based on cell information of the second cell. If the user terminal does not receive a response for the radio resource connection request from the second cell before the driven second retransmission timer is expired, the user terminal may re-request the radio resource connection to the first cell based on the expiration of the driven Tcp-cell timer. That is, the user terminal may re-request the radio resource connection to the first cell if the driven Tcp-cell timer is expired.

FIG. 7 is a flowchart illustrating a process of searching for a cell and a process of initializing a radio resource connection according to an exemplary embodiment of the present is invention.

Referring to FIG. 7, in operation 711, the user terminal obtains electric field strength for each of the cells that exist around the user terminal. For example, the electric field strength for each of the cells that exist around the user terminal may be measured according to reception strength of an SIB signal.

In operation 713, the user terminal generates a list of the cells based on the electric field strength for each of the cells.

In operation 715, the user terminal selects the first cell that satisfies the optimal condition for radio communication based on the generated list. If the user terminal does not find a best-cell in operation 715, the user terminal may again perform cell searching.

After the user terminal finds the best-cell, the user terminal may initialize a variable for determining whether a request for the radio resource connection is the first trial for the radio resource connection to each of the first and second cells in operation 717. In an example, the variable for determining whether a request for the radio resource connection is the first trial for the radio resource connection to the first cell may be represented by ‘First RCR_For_Best’. The initialization of the ‘First RCR_For_Best’ is to set the value of the ‘First RCR_For_Best’ as ‘TRUE’. If the value of the ‘First RCR_For_Best’ is ‘FALSE’, the radio resource connection request to the first cell is not the first trial.

The user terminal may perform process ‘A’ illustrated in FIG. 8 after operation 717.

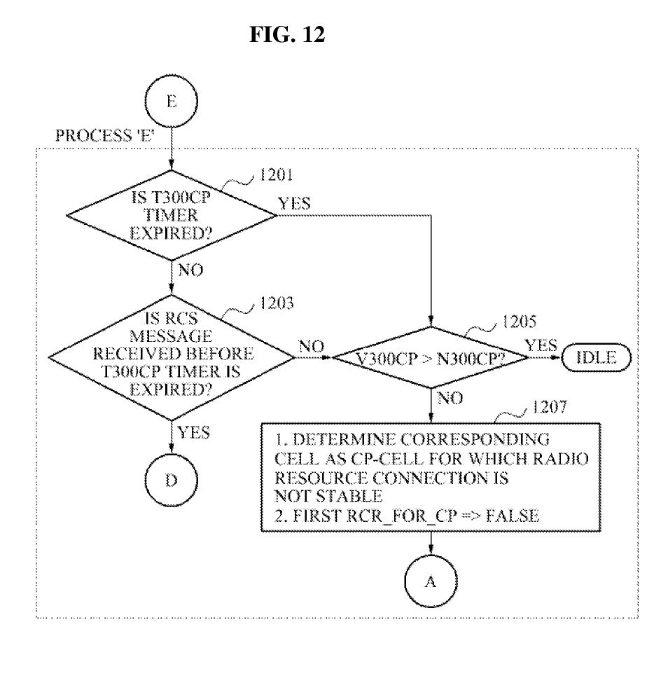

FIG. 8 is a flowchart illustrating an example of process ‘A’ referred to in FIG. 7, FIG. 9, and FIG. 12 according to an exemplary embodiment of the present invention.

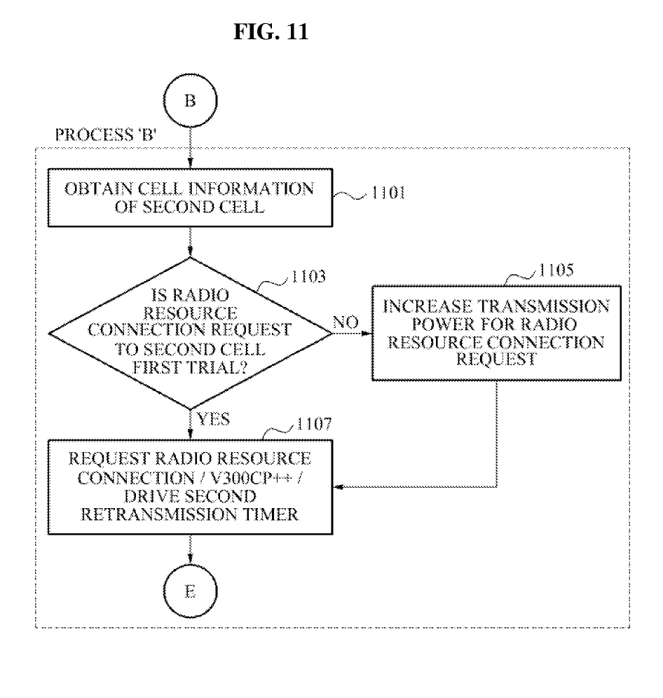

Referring to FIG. 8, in operation 811, the user terminal determines the expiration of the Tcp-cell timer or whether a radio resource connection request is the first trial for the first cell. If the radio resource connection request to the first cell is the first trial for the first cell, the Tcp-cell timer is not driven. If the Tcp-cell timer is not expired or the radio resource connection request to the first cell is not a first trial for the first cell, the user terminal performs process ‘B’ illustrated in FIG. 11.

In operation 813, the user terminal obtains cell information of the first cell. In this instance, the cell information of the first cell may be stored in a storage unit of the terminal during the cell searching process.

In operation 815, the user terminal determines whether a request for the radio resource connection is the first trial for the first cell. That is, the user terminal determines whether the radio resource connection request is the first request to the first cell or re-request to the first cell.

If the radio resource connection request to the first cell is a first trial, the user terminal requests the radio resource connection to the first cell, increases the value of V300 by ‘1’, and then drives the first retransmission timer in operation 819.

If the radio resource connection request to the first cell is not a first trial, the user terminal may increase transmission power for the radio resource connection request in operation 817 and then perform operation 819.

The user terminal may perform process ‘C’ illustrated in FIG. 9 after operation 819.

FIG. 9 is a flowchart illustrating an example of process ‘C’ referred to in FIG. 8 according to an exemplary embodiment of the present invention.

Referring to FIG. 9, in operation 921, the user terminal identifies whether the T300 timer is expired. That is, the user terminal identifies the expiration of the first retransmission timer in operation 921.

If the T300 timer is not expired, the user terminal determines whether an ‘RCS message’ is received before the T300 timer is expired in operation 923. If the RCS message is received before the T300 timer is expired, the user terminal performs process ‘D’ illustrated in FIG. 13. If the RCS message is not received before the T300 timer is expired, the user terminal performs operation 925.

If the T300 timer is expired, the user terminal compares V300 with N300 in operation 925. If the V300 is greater than the N300, the user terminal may transit to an idle state and may perform the cell searching again. If the V300 is smaller than or identical to the N300, the user terminal performs operation 927.

In operation 927, the user terminal determines a corresponding cell as a CP-cell of which radio resource connection is not stable. In operation 927, the user terminal may also change the value of ‘First RCR_For_Best’ into ‘FALSE’.

In operation 928, the user terminal determines whether the Tcp-cell timer is driven. If the Tcp-cell timer is driven, the user terminal performs process ‘A’. If the Tcp-cell timer is not driven, the user terminal drives the Tcp-cell timer in operation 929 and then performs process ‘A’.

Referring to operations 921 to 929, in the failure of the radio resource connection to the first cell, the user terminal compares the number of radio resource connection requests to the first cell with a reference value obtained from the cell information of the first cell. If the number of radio resource connection requests to the first cell (‘V300’) is not larger than the reference value (‘N300’), the user terminal determines the first cell as a CP-cell.

FIG. 10 is a flowchart illustrating a procedure of a portion of operation 540 illustrated in FIG. 5 according to an exemplary embodiment of the present invention.

Referring to FIG. 10, following from operation 530 in FIG. 5, in operation 1041, the user terminal drives the second retransmission timer based on the cell information of the second cell.

In operation 1043, the user terminal determines a failure of the radio resource connection to the second cell, based on the driven second retransmission timer and the reception of the response signal for the radio resource connection request to the second cell.

In operation 1045, the user terminal may re-request the radio resource connection to the first cell based on the expiration of the driven Tcp-cell timer.

FIG. 11 is a flowchart illustrating an example of process ‘B’ referred to in FIG. 8 according to an exemplary embodiment of the present invention.

In operation 1101, the user terminal obtains cell information of the second cell. In this instance, the cell information of the second cell may be stored in a storage unit of the user terminal during a cell searching process. Also, the second cell may be a cell for which conditions for radio communication are superior to the cells except cells determined as CP-cells at the time of operation 1101.

In operation 1103, the user terminal determines whether a request for the radio resource connection to the second cell is the first trial for the second cell. That is, the user terminal determines whether the radio resource connection request to the second cell is the first request for the second cell.

If the radio resource connection request to the second cell is the first trial, the user terminal requests a radio resource connection to the second cell, increases the value of V300cp by ‘1’, and drives the second retransmission timer in operation 1107.

If the radio resource connection request to the second cell is not the first trial, the user terminal may increase transmission power for the radio resource connection request in operation 1105 and then perform operation 1107.

The user terminal may perform process ‘E’ illustrated in FIG. 12 after operation 1107.

FIG. 12 is a flowchart illustrating an example of process ‘E’ referred to in FIG. 11 according to an exemplary embodiment of the present invention.

Referring to FIG. 12, in operation 1201, the user terminal identifies the expiration of a T300cp. That is, the user terminal identifies the expiration of the second retransmission timer in operation 1201.

If the T300cp timer is not expired, the user terminal determines whether an ‘RCS message’ is received from the second cell before the T300cp timer is expired, in operation 1203. If the RCS message is received from the second cell before the T300cp timer is expired, the user terminal performs process ‘D’ illustrated in FIG. 13. If the RCS message is not received before the T300cp timer is expired, the user terminal performs operation 1205.

If the T300cp timer is expired, the user terminal compares V300cp with N300cp in operation 1205. If the V300cp is greater than N300cp, the user terminal may transit to an idle state and may perform the cell searching again. If the V300cp is smaller than or equal to the N300cp, the user terminal performs operation 1207.

In operation 1207, the user terminal determines a corresponding cell, the second cell, as a CP-cell for which radio resource connection is not stable. In operation 1207, the user terminal may change the value of ‘First RCR_For_CP’ into ‘FALSE’. The ‘First RCR_For_CP’ is is a variable for determining whether a request for the radio resource connection to the second cell is the first trial of the radio resource connection request for the second cell.

The user terminal may perform process ‘A’ after to operation 1207.

Also, after operation 1207, the user terminal may drive a timer for stopping the re-request for the radio resource connection to the second cell for a certain period of time and then perform process ‘A’.

FIG. 13 is a flowchart illustrating an example of process ‘D’ referred to in FIG. 5, FIG. 6, FIG. 9, FIG. 10, and FIG. 12 according to an exemplary embodiment of the present invention.

The process illustrated in FIG. 13 is a process for receiving a response for a radio resource connection request from a cell and then setting up a radio resource connection.

Referring to FIG. 13, the user terminal processes an ‘RCS message’ for radio resource connection in operation 1310 and performs an authentication process in operation 1320, thereby completing the radio resource connection.

The values of the ‘First RCR_For_Best’, and ‘First RCR_For_CP’ may be changed back to ‘TRUE’ after the successful completion of the radio resource connection or after the transition into the corresponding idle state. Alternatively, the value of the ‘First RCR_For_Best’ may be changed to ‘FALSE’ after transmitting a request for the radio resource connection to the first cell. The Tcp-cell timer may be driven to start if a first retransmission timer corresponding to the first cell is expired.

The exemplary embodiments according to the present invention may be recorded in non-transitory computer-readable media including program instructions to implement various operations embodied by a computer. The media may also include, alone or in combination with is the program instructions, data files, data structures, and the like. The media and program instructions may be those specially designed and constructed for the purposes of the present invention, or they may be of the kind well-known and available to those having skill in the computer software arts.

The above-mentioned exemplary embodiments may enable to provide a dynamic radio resource connection request, to enhance success probability of a radio resource connection with less consumption of power, and to avoid transmission channel waste.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for a radio resource connection, comprising:
transmitting a request for a radio resource connection to a first cell, and driving a first retransmission timer based on cell information of the first cell;
determining a failure of the radio resource connection to the first cell based on the first retransmission timer;
driving a Tcp-cell timer for stopping re-request of the radio resource connection to the first cell for a period of time; and
requesting a radio resource connection to a second cell.

2. The method of claim 1, further comprising:
receiving a system information block from the first cell;
obtaining electric field strength of the system information block;
generating a list of cells including the first cell based on at least one of the electric field strength, degree of interference of a reception signal transmitted from the first cell, and quality of the reception signal; and
selecting the first cell based on the list of cells.

3. The method of claim 2, further comprising:
initializing a variable for determining whether the request for the radio resource connection to the first cell is a first request of the radio resource connection to the first cell.

4. The method of claim 1, wherein the cell information of the first cell comprises a number of retransmissions of a ‘radio resource control (RRC) connection request message’ allowed in the first cell, a value of a retransmission request timer of the ‘RRC connection request message’ for the first cell, and a value of the Tcp-cell timer, and
the value of the Tcp-cell timer is smaller than the value of the retransmission request timer of the ‘RRC connection request message’ for the first cell.

5. The method of claim 1, further comprising:
increasing transmission power for the request for the radio resource connection if the request for the radio resource connection to the first cell is not a first trial for the first cell.

6. The method of claim 1, further comprising:
comparing a number of radio resource connection requests to the first cell with a reference value obtained from the cell information of the first cell;
determining the first cell as a capricious cell if the number of radio resource connection requests is not larger than the reference value; and
identifying whether the Tcp-cell timer is driven.

7. The method of claim 1, further comprising:
driving a second retransmission timer based on cell information of the second cell;
determining a failure of the radio resource connection to the second cell based on the second retransmission timer; and
re-requesting the radio resource connection to the first cell based on a status of the Tcp-cell timer.

8. A method for a radio resource connection, comprising:
requesting a radio resource connection to a first cell;
requesting a radio resource connection to a second cell if the first cell is determined as a capricious cell; and
determining whether to perform a re-request of a radio resource connection to the first cell if the second cell is determined as a capricious cell.

9. The method of claim 8, further comprising:
comparing a number of radio resource connection requests to the first cell with a reference value obtained from cell information of the first cell;
determining the first cell as the capricious cell if the number of radio resource connection requests to the first cell is not larger than the reference value; and
driving a Tcp-cell timer for stopping the re-request of the radio resource connection to the first cell for a period of time.

10. The method of claim 9, further comprising:
driving a second retransmission timer based on cell information of the second cell; and
performing the re-request of the radio resource connection to the first cell based on an expiration of the Tcp-cell timer.

11. The method of claim 9, wherein the cell information of the first cell comprises a number of retransmissions of an ‘RRC connection request message’ allowed in the first cell, a value of a retransmission request timer of the ‘RRC connection request message’ for the first cell, and a value of the Tcp-cell timer, and
the value of the Tcp-cell timer is smaller than the value of the retransmission request timer of the ‘RRC connection request message’ for the first cell.

12. A terminal comprising:
a communication unit to transmit and receive a message for radio resource connection to and from a base station;
a control unit to request a radio resource connection to a first cell, to request the radio resource connection to a second cell if the first cell is determined as a capricious cell (CP-cell), and to determine whether to re-request the radio resource connection to the first cell based on a Tcp-cell timer; and
a timer management unit to manage the Tcp-cell timer for stopping re-request for the radio resource connection to the first cell for a period of time.

13. The terminal of claim 12, further comprising:
a storage unit to store a list of cells including the first cell and the second cell, a number of radio resource connection requests to the first cell, system broadcasting information of the first cell, and information of a cell determined as a capricious cell.

14. The terminal of claim 12, wherein if a request for the radio resource connection to the first cell is not a first trial for the first cell, the control unit increases transmission power of request for the radio resource connection.

15. The terminal of claim 12, wherein if it is determined that a number of radio resource connection requests to the first cell is not larger than a reference value obtained from cell information of the first cell, the control unit determines the first cell as a capricious cell, and controls the timer management unit to drive the Tcp-cell timer.

16. The terminal of claim 12, wherein if the terminal does not receive a response for a radio resource connection request from the second cell before a second retransmission timer is expired, the control unit re-requests the radio resource connection to the first cell based on an expiration of the Tcp-cell timer.

17. The terminal of claim 12, wherein cell information of the first cell comprises a number of retransmissions of an ‘RRC connection request message’ allowed in the first cell, a value of a retransmission request timer of the ‘RRC connection request message’ provided from the first cell, and
a value of the Tcp-cell timer is set smaller than the value of the retransmission request timer of the ‘RRC connection request message’.

18. A terminal comprising:
a communication unit to transmit a first request for a radio resource connection and to receive a response to the first request;
a control unit to generate the first request, to select a first cell based on the response, and to determine whether to transmit a second request to the first cell based on a timer; and
a timer management unit to start the timer.

19. The terminal of claim 18, wherein the control unit determines whether to transmit the second request to the first cell if the timer is expired, and further selects a second cell based on a response signal from the second cell, and determines whether to transmit a request signal for a radio connection to the second cell based on the timer,
the communication unit transmits a request signal to request a radio resource connection to the second cell, and
the timer management unit start the timer if the communication unit fails to establish the radio resource connection with the first cell.

20. The terminal of claim 19, further comprising:
a storage unit to store cell information of the first cell, the cell information comprising a number of retransmissions of an ‘RRC connection request message’ allowed in the first cell and a value of a retransmission request timer of the ‘RRC connection request message’ provided from the first cell, and a value of the timer is smaller than that of the retransmission request timer of the ‘RRC connection request message’, and to store a list of cells that exist around the terminal, a number of radio resource connection requests to the first cell, the system broadcasting information of the first cell and a list of capricious cells for which radio resource connections are not stable, wherein
the timer management unit controls a first retransmission timer, a second retransmission timer, and the timer,
the timer is used to delay a transmission of the second request to the first cell until the timer expires,
the first cell is a cell that satisfies an optimal condition for radio communication among cells that exist around the terminal, and
the control unit determines to transmit the request signal for a radio resource connection to the second cell if the communication unit does not receive a response from the first cell before the first retransmission timer for the first cell is expired, determines to transmit the second request for a radio resource connection to the first cell if the communication unit does not receive a response signal for the radio resource connection request from the second cell before the second retransmission timer for the second cell is expired, and controls to increase transmission power of the second request or third request.
